(19) United States
(12) Patent Application Publication
(10) Pub. No.: US 2025/0131029 A1
(43) Pub. Date: Apr. 24, 2025

(54) MODEL EMERGENT CAPABILITY ANALYSIS

(71) Applicant: International Business Machines Corporation, Armonk, NY (US)

(72) Inventors: Giulio Zizzo, Dublin (IE); Beat Buesser, Ashtown (IE); Kieran Fraser, Raheny (IE); Ambrish Rawat, Dublin (IE); Michael Gringo Angelo Reglos Bayona, Dublin (IE)

(73) Assignee: International Business Machines Corporation, Armonk, NY (US)

(21) Appl. No.: 18/492,163

(22) Filed: Oct. 23, 2023

(51) Int. Cl. G06F 16/35; G06F 16/38; G06F 40/40

(52) U.S. Cl. CPC G06F 16/35; G06F 16/38; G06F 40/40

(57) ABSTRACT

An embodiment trains, using a database of tasks, a classifier model to classify an input task into a task category. An embodiment generates a plurality of prompts. An embodiment applies a first prompt in the plurality of prompts to a trained model, the trained model producing a first model output in response to the first prompt. An embodiment classifies, using the trained classifier model, the first model output into a first task category. An embodiment determines that the first task category is an undesired task category. An embodiment adjusts, responsive to determining the first task category is the undesired task category, the trained model, the adjusting altering a capability of the trained model to perform a task in the first task category.

### BACKGROUND

The present invention relates generally to machine learning model analysis. More particularly, the present invention relates to a method, system, and computer program for model emergent capability analysis.

A language model is a probabilistic model of a human language that can generate probabilities of a series of words, based on training using text in one or more languages the model was trained on. The training data is typically unlabeled and unstructured, and need not be restricted to text. A large language model (LLM) is an artificial neural network-based language model that is large, typically including a billion or more weights. An LLM works by taking an input text and repeatedly predicting the next word or token (a text unit similar to a word). Some LLMs are able to process audio, still images and video, and other input modes as well as text. Some examples of presently available LLMs are Generative Pre-trained Transformer 3 (GPT-3) and GPT-4, Pathways Language Model (PaLM) and PaLM 2, and Large Language Model Meta AI (LlaMa). (GPT-3 and GPT-4 are registered trademarks of OpenAI OpCo, LLC in the United States and other countries.) A foundation model or base model is a machine learning model, such as an LLM, that is trained on a broad range of data. A foundation model is adaptable to a more specific knowledge area (e.g., given additional vocabulary relating to chemistry or computer science) or more specific task (e.g., text to image generation), generating a fine-tuned model without the need to retrain the (typically much larger) foundation model.

LLMs and other models often exhibit one or more emergent capabilities (also referred to as emerging capabilities and emergent abilities). Emergent capabilities are unexpected model capabilities which are not explicitly trained for. For example, one LLM, GPT-3, was trained to predict the next word, but has been shown to be capable of additional tasks such as mathematics, software coding, and zero-shot classification (in which a model trained on a set of labeled examples is then able to classify new examples into previously unseen classes). In addition, a foundation model might interact with other models (e.g., via an application program interface (API), and the resulting combination might exhibit an emergent capability that is not apparent when the foundation model is used alone. Some emergent capabilities (e.g., an unexpected ability to generate software code) might be desirable additions to a model's functionality, while others (e.g., an unexpected disclosure of private information) might not be desirable additions to a model's functionality.

The illustrative embodiments recognize that those responsible for a model, particularly a foundation model on which hundreds of fine-tuned models might depend) want to know what the model is capable of, both for marketing purposes and to prevent deployment of an undesired capability. For example, a model trained to generate English text might also be able to generate computer source code, which could be marketed as a code-generation product instead of an English text-generation product. As another example, consider a model trained on financial transaction data for the task of detecting borrowers who may default on loan repayments. The model's output (a risk of loan default for a borrower with a particular set of characteristics) alone might not be enough to identify a particular borrower. However, if other users discover that the model performs other tasks sufficiently well (e.g., predicting borrowers' likelihood of purchasing a product with a particular set of features, identifying borrowers' professions or job titles for use in a marketing campaign targeted at particular professionals, and identifying borrowers' salaries for use in a marketing campaign targeted at high-net-worth individuals), the model could be used to identify an unexpected and unwanted combination of borrower characteristics.

However, because emergent capabilities are unexpected, it is difficult for human experts to design tests to determine whether or not a model has a specific capability. In addition, relying on users to report unexpected model behavior, once a model is deployed, means that a model's undesired capability has already been deployed as well. Thus, the illustrative embodiments recognize that there is an unmet need for automated, systematic capability testing of a model, to detect and assess an emergent capability of the model.

### SUMMARY

The illustrative embodiments provide for model emergent capability analysis. An embodiment includes training, using a database of tasks, a classifier model to classify an input task into a task category, the training resulting in a trained classifier model. An embodiment includes generating a plurality of prompts. An embodiment includes applying a first prompt in the plurality of prompts to a trained model, the trained model producing a first model output in response to the first prompt. An embodiment includes classifying, using the trained classifier model, the first model output into a first task category. An embodiment includes determining that the first task category is an undesired task category. An embodiment includes adjusting, responsive to determining the first task category is the undesired task category, the trained model, the adjusting altering a capability of the trained model to perform a task in the first task category. Other embodiments of this aspect include corresponding computer systems, apparatus, and computer programs recorded on one or more computer storage devices, each configured to perform the actions of the embodiment. Thus, an embodiment provides model emergent capability analysis.

In a further embodiment, generating the plurality of prompts comprises training a reinforcement learning agent to reward a prompt invoking generation of a novel task higher than a prompt invoking generation of a non-novel task, the training resulting in a trained reinforcement learning agent. Thus, an embodiment provides additional detail of prompt generation used in model emergent capability analysis.

In a further embodiment, generating the plurality of prompts comprises using the trained reinforcement learning agent to reward a derived prompt, the derived prompt derived from an existing prompt. Thus, an embodiment provides additional detail of prompt generation used in model emergent capability analysis.

In a further embodiment, generating the plurality of prompts comprises prompting the trained model to generate a generated prompt, the generated prompt resulting in a desired output of the trained model. Thus, an embodiment provides additional detail of prompt generation used in model emergent capability analysis.

In a further embodiment, generating the plurality of prompts comprises adjusting an initial prompt producing an initial model output, the adjusting generated an adjusted prompt producing an adjusted model output, the initial model output having an initial correctness lower than a correctness threshold, the adjusted model output having an adjusted correctness higher than the initial correctness. Thus, an embodiment provides additional detail of prompt generation used in model emergent capability analysis.

In a further embodiment, the adjusted prompt has a semantic meaning above a semantic meaning threshold. Thus, an embodiment provides additional detail of prompt generation used in model emergent capability analysis.

An embodiment includes a computer usable program product. The computer usable program product includes a computer-readable storage medium, and program instructions stored on the storage medium.

An embodiment includes a computer system. The computer system includes a processor, a computer-readable memory, and a computer-readable storage medium, and program instructions stored on the storage medium for execution by the processor via the memory.

### BRIEF DESCRIPTION OF THE DRAWINGS

The novel features believed characteristic of the invention are set forth in the appended claims. The invention itself, however, as well as a preferred mode of use, further objectives, and advantages thereof, will best be understood by reference to the following detailed description of the illustrative embodiments when read in conjunction with the accompanying drawings, wherein:

FIG. 1 depicts a block diagram of a computing environment in accordance with an illustrative embodiment;

FIG. 2 depicts a flowchart of an example process for loading of process software in accordance with an illustrative embodiment;

FIG. 3 depicts a block diagram of an example configuration for model emergent capability analysis in accordance with an illustrative embodiment;

FIG. 4 depicts a flow diagram of an example configuration for model emergent capability analysis in accordance with an illustrative embodiment; and

FIG. 5 depicts a flowchart of an example process for model emergent capability analysis in accordance with an illustrative embodiment.

### DETAILED DESCRIPTION

The illustrative embodiments recognize that there is an unmet need for automated, systematic capability testing of a model, to detect and assess an emergent capability of the model. The present disclosure addresses the deficiencies described above by providing a process (as well as a system, method, machine-readable medium, etc.) that trains a classifier model to classify an input task into a task category, generates a plurality of prompts, applies a first prompt in the plurality of prompts to a trained model, the trained model producing a first model output in response to the prompt, uses the trained classifier model to classify the first model output into a first task category, determines that the first task category is an undesired task category, and adjusts the trained model, the adjusting altering a capability of the trained model to perform a task in the first task category. Thus, the illustrative embodiments provide for model emergent capability analysis.

An illustrative embodiment has access to a database, or dataset, of tasks. A task is a behavior, including one or a series of steps, performed by a model or a human, labelled with a category or description of the task. One presently available technique for assembling a database of tasks includes obtaining a sequence of observations of performance of one or more activities, clustering the observations to find commonly repeated sequences which could indicate repeating behaviors (i.e., tasks), and having human annotators distinguish between input sequences (which could be used as prompts) and subsequent outcomes, distinguish between successful and unsuccessful outcomes, and classify a sequence into one of a predefined set of task labels or task categories. Some example sources of observations of performance of one or more activities are data of sequences of websites visited and actions taken at one or more websites (e.g., while shopping online), data gathered via sensors (e.g., tracking object movement in a warehouse or along a supply chain), and transaction data (e.g., financial transaction data) among accounts or applications. Some examples of tasks involve product recommendations, warehouse resupply scheduling, and financial fraud detection. Task datasets are also available for purchase. Some presently available models (e.g., GPT-4) are also usable to generate new tasks (already-labelled, or for humans to label) and variations on existing tasks.

An illustrative embodiment uses a presently available technique to train a classifier model to classify an input task into a task category in a plurality of predefined task categories. The technique uses a database of categorized tasks as training and testing data during model training. Some non-limiting examples of predefined task categories are source code generation, mathematical reasoning, product recommendations, warehouse resupply scheduling, financial fraud detection, and the like.

An embodiment generates a plurality of prompts. A prompt is an input to a model, intended to invoke a particular model's capability.

In one prompt generation implementation, an embodiment uses a presently available technique to train a reinforcement learning agent against one or more foundation models (of which at least one foundation model has a capability being prompted for) to generate prompts invoking a variety of tasks. In the reinforcement learning agent, creating prompts that generate model output that a trained task classifier correctly classifies as a novel task is rewarded. In one embodiment, the largest reward is given for new tasks, with a decreasing reward (according to a particular decay function) for tasks that the reinforcement learning agent has already triggered.

In another prompt generation implementation, an embodiment uses a presently available genetic algorithm technique to alter one or more existing prompts in a prescribed manner, and rewarding prompts that generate model output that a trained task classifier correctly classifies as a novel task. In one embodiment, the largest reward is given for new tasks, with a decreasing reward (according to a particular decay function) for tasks that the reinforcement learning agent has already triggered.

In another prompt generation implementation, an embodiment uses a presently available model inversion technique to generate one or more prompts that best result in a desired model output. A model inversion technique starts with a desired model output (e.g., generating computer source code in the C language) and attempts to discover prompts that generate the desired result. One embodiment uses a presently available model inversion technique to prime the model, resulting in better prompts. For example, a model might be given several examples of a desired result and requested to provide a prompt that would produce a result resembling the examples. For example, a model might be prompted with several examples of C code and asked to provide a prompt that would produce a result resembling the given examples.

In another prompt generation implementation, an embodiment uses a presently available adversarial example technique to generate prompts. An adversarial example technique starts with an initial prompt (e.g., from a task database) for which a model produces a result with a correctness below a correctness threshold, and adjusts the initial prompt in an attempt to cause the model to generate a result with a correctness closer to or above the correctness threshold. An embodiment adjusts the initial prompt by adding one or more characters to the initial prompt, removing one or more characters from the initial prompt, or replacing one or more characters in the initial prompt with different characters. An embodiment also uses a presently available natural language processing or natural language understanding technique to determine if an adjusted prompt retains a semantic meaning above a semantic meaning threshold (i.e., the adjusted prompt is not a meaningless string of letters and numbers) and to determine if an adjusted prompt is merely a request to echo the desired result.

To evaluate a trained model's capabilities, an embodiment applies a prompt to the model, and the model responds to the prompt by producing a model output. The applied prompt is generated by an embodiment, or obtained from a task database or another source.

An embodiment uses the trained classifier model to classify the model output into one of the classifier model's predefined task categories. Another embodiment uses the trained classifier model and the applied prompt to classify the model output into one of the classifier model's predefined task categories. For example, if the model responded to the prompt “what is x in x²+9=25” with “x=” followed by a number, an embodiment might use the trained classifier model to classify the model output into the mathematical reasoning category. Note that the trained classifier model might classify the model output into the mathematical reasoning category even if the model's answer to the equation is not mathematically correct, as long as the answer has above a threshold amount of semantic similarity to a mathematically correct answer. As another example, if the model responded to the prompt “write C code to put a set of strings in alphabetical order” with some lines of C code, an embodiment might use the trained classifier model to classify the model output into the source code generation category. Note that the trained classifier model might classify the model output into the code generation category even if the model's answer does not include the most efficient implementation of the requested code or includes a minor error, as long as the answer has above a threshold amount of semantic similarity to an answer deemed acceptable. The strictness of the trained classifier model's criteria for assigning a model output to a particular category is adjustable during model training. In one embodiment, the strictness of the trained classifier model's criteria for assigning a model output to a particular category is a user-defined parameter. In addition, if a user specifies that model output can be assigned to a particular category (e.g., mathematical reasoning or source code generation) only if the result has above a threshold amount of correctness, one embodiment uses a presently available technique to evaluate the correctness of a result. For example, natural language understanding techniques are presently available to extract a mathematical expression from text output by an LLM and equation solving techniques are presently available to evaluate a correctness of the extracted mathematical expression. As another example, source code checking techniques are presently available to evaluate a correctness of generated source code.

An embodiment reports a model output's task categories, individually or aggregated, and automatically or upon request. For example, one embodiment might repeat a prompt generation and model output classification in response to generate prompts once per week, and report when a model generates above a threshold number of responses in a particular category (i.e., the model now appears to be able to perform a task in that category). As another example, an embodiment might generate an aggregated report showing how many responses were in each category, or in a subset of the available categories (e.g., so far the model has produced five outputs in the code generation category and 2500 outputs in the mathematical reasoning category).

An embodiment determines whether or not a model output is in an undesired task category. Some non-limiting examples of an undesired task category are the disclosure of private information (e.g., an employee's tax identification number or password), a type of model output that is inconsistent with a model's purpose (e.g., generating source code by a model intended to generate poetry or French text), and a type of output that might give rise to an unacceptable amount of legal or business risk (e.g., disclosure of an individual's legally protected information or a trade secret), and the like. If a model output is in an undesired task category, an embodiment adjusts the model. The adjustment alters a capability of the trained model to perform a task in the first task category. To adjust a model, an embodiment uses one or more presently available model alteration techniques to perform additional model training (optionally, with adjusted training data), adjust a limit on a model's output in response to a specific prompt or type of prompt, or a limit on a model's output to a specific user or category of user, or performs another model adjustment. For example, if a model output is classified in an (undesired) humor category, an embodiment might retrain a model to adjust the type of humor being generated, instruct the model to explain that it is unable to generate a requested joke, instruct the model to explain that it is unable to generate a requested joke to a child user, and the like.

For the sake of clarity of the description, and without implying any limitation thereto, the illustrative embodiments are described using some example configurations. From this disclosure, those of ordinary skill in the art will be able to conceive many alterations, adaptations, and modifications of a described configuration for achieving a described purpose, and the same are contemplated within the scope of the illustrative embodiments.

Furthermore, simplified diagrams of the data processing environments are used in the figures and the illustrative embodiments. In an actual computing environment, additional structures or components that are not shown or described herein, or structures or components different from those shown but for a similar function as described herein may be present without departing the scope of the illustrative embodiments.

Furthermore, the illustrative embodiments are described with respect to specific actual or hypothetical components only as examples. Any specific manifestations of these and other similar artifacts are not intended to be limiting to the invention. Any suitable manifestation of these and other similar artifacts can be selected within the scope of the illustrative embodiments.

The examples in this disclosure are used only for the clarity of the description and are not limiting to the illustrative embodiments. Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Furthermore, the illustrative embodiments may be implemented with respect to any type of data, data source, or access to a data source over a data network. Any type of data storage device may provide the data to an embodiment of the invention, either locally at a data processing system or over a data network, within the scope of the invention. Where an embodiment is described using a mobile device, any type of data storage device suitable for use with the mobile device may provide the data to such embodiment, either locally at the mobile device or over a data network, within the scope of the illustrative embodiments.

The illustrative embodiments are described using specific code, computer readable storage media, high-level features, designs, architectures, protocols, layouts, schematics, and tools only as examples and are not limiting to the illustrative embodiments. Furthermore, the illustrative embodiments are described in some instances using particular software, tools, and data processing environments only as an example for the clarity of the description. The illustrative embodiments may be used in conjunction with other comparable or similarly purposed structures, systems, applications, or architectures. For example, other comparable mobile devices, structures, systems, applications, or architectures therefor, may be used in conjunction with such embodiment of the invention within the scope of the invention. An illustrative embodiment may be implemented in hardware, software, or a combination thereof.

The examples in this disclosure are used only for the clarity of the description and are not limiting to the illustrative embodiments. Additional data, operations, actions, tasks, activities, and manipulations will be conceivable from this disclosure and the same are contemplated within the scope of the illustrative embodiments.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

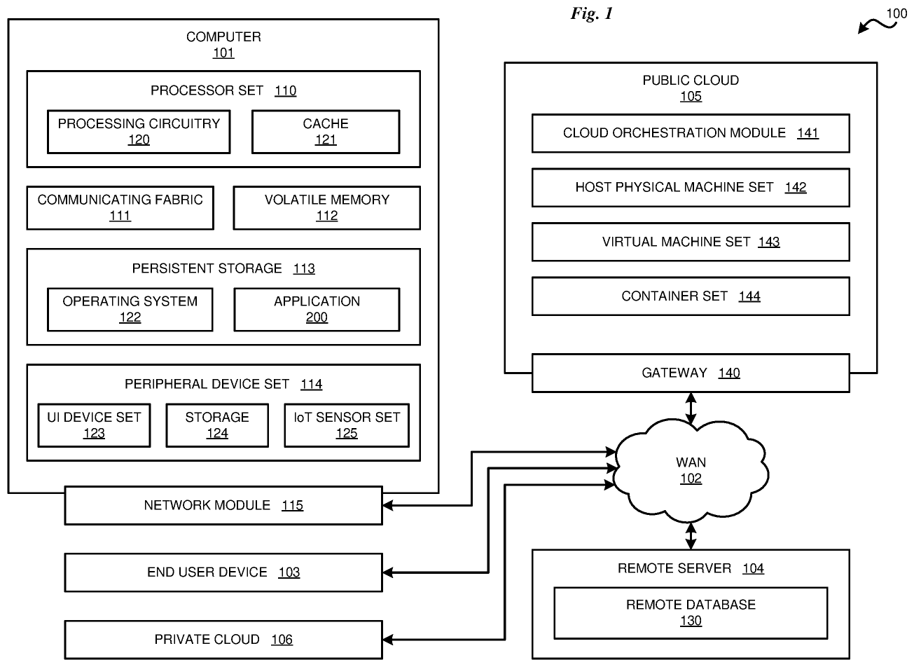

With reference to FIG. 1, this figure depicts a block diagram of a computing environment 100. Computing environment 100 contains an example of an environment for the execution of at least some of the computer code involved in performing the inventive methods, such as a module 200 implementing model emergent capability analysis. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile.

In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102.

Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Measured service: cloud systems automatically control and optimize resource use by leveraging a metering capability at some level of abstraction appropriate to the type of service (e.g., storage, processing, bandwidth, and active user accounts). Resource usage can be monitored, controlled, reported, and invoiced, providing transparency for both the provider and consumer of the utilized service.

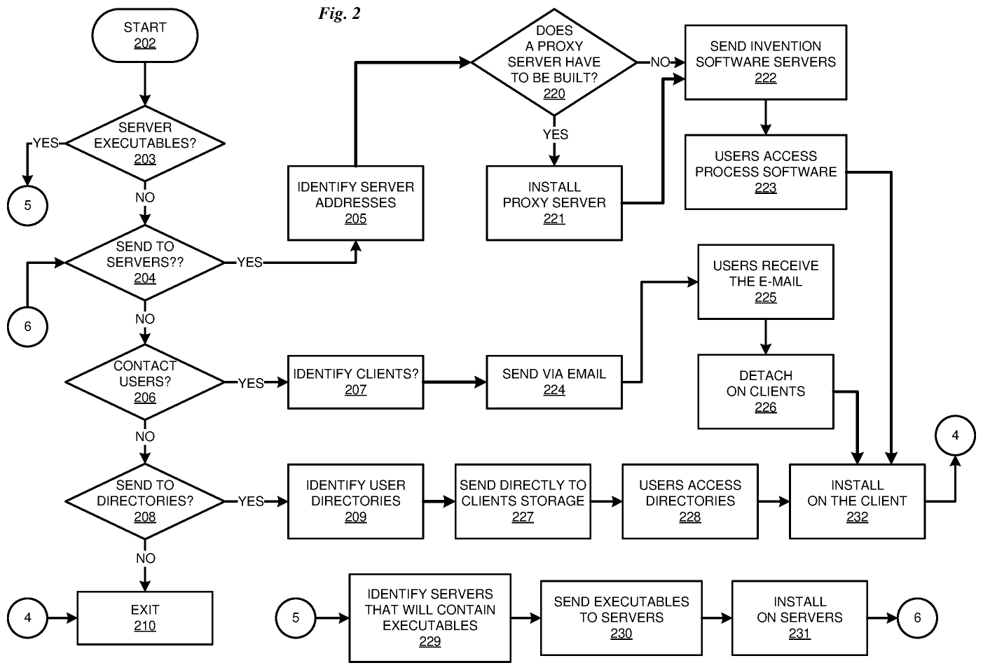

With reference to FIG. 2, this figure depicts a flowchart of an example process for loading of process software in accordance with an illustrative embodiment. The flowchart can be executed by a device such as computer 101, end user device 103, remote server 104, or a device in private cloud 106 or public cloud 105 in FIG. 1.

While it is understood that the process software implementing model emergent capability analysis may be deployed by manually loading it directly in the client, server, and proxy computers via loading a storage medium such as a CD, DVD, etc., the process software may also be automatically or semi-automatically deployed into a computer system by sending the process software to a central server or a group of central servers. The process software is then downloaded into the client computers that will execute the process software. Alternatively, the process software is sent directly to the client system via e-mail. The process software is then either detached to a directory or loaded into a directory by executing a set of program instructions that detaches the process software into a directory. Another alternative is to send the process software directly to a directory on the client computer hard drive. When there are proxy servers, the process will select the proxy server code, determine on which computers to place the proxy servers' code, transmit the proxy server code, and then install the proxy server code on the proxy computer. The process software will be transmitted to the proxy server, and then it will be stored on the proxy server.

Step 202 begins the deployment of the process software. An initial step is to determine if there are any programs that will reside on a server or servers when the process software is executed (203). If this is the case, then the servers that will contain the executables are identified (229). The process software for the server or servers is transferred directly to the servers' storage via FTP or some other protocol or by copying though the use of a shared file system (230). The process software is then installed on the servers (231).

Next, a determination is made on whether the process software is to be deployed by having users access the process software on a server or servers (204). If the users are to access the process software on servers, then the server addresses that will store the process software are identified (205).

A determination is made if a proxy server is to be built (220) to store the process software. A proxy server is a server that sits between a client application, such as a Web browser, and a real server. It intercepts all requests to the real server to see if it can fulfill the requests itself. If not, it forwards the request to the real server. The two primary benefits of a proxy server are to improve performance and to filter requests. If a proxy server is required, then the proxy server is installed (221). The process software is sent to the (one or more) servers either via a protocol such as FTP, or it is copied directly from the source files to the server files via file sharing (222). Another embodiment involves sending a transaction to the (one or more) servers that contained the process software, and have the server process the transaction and then receive and copy the process software to the server's file system. Once the process software is stored at the servers, the users via their client computers then access the process software on the servers and copy to their client computers file systems (223). Another embodiment is to have the servers automatically copy the process software to each client and then run the installation program for the process software at each client computer. The user executes the program that installs the process software on his client computer (232) and then exits the process (210).

In step 206 a determination is made whether the process software is to be deployed by sending the process software to users via e-mail. The set of users where the process software will be deployed are identified together with the addresses of the user client computers (207). The process software is sent via e-mail to each of the users' client computers (224). The users then receive the e-mail (225) and then detach the process software from the e-mail to a directory on their client computers (226). The user executes the program that installs the process software on his client computer (232) and then exits the process (210).

Lastly, a determination is made on whether the process software will be sent directly to user directories on their client computers (208). If so, the user directories are identified (209). The process software is transferred directly to the user's client computer directory (227). This can be done in several ways such as, but not limited to, sharing the file system directories and then copying from the sender's file system to the recipient user's file system or, alternatively, using a transfer protocol such as File Transfer Protocol (FTP). The users access the directories on their client file systems in preparation for installing the process software (228). The user executes the program that installs the process software on his client computer (232) and then exits the process (210).

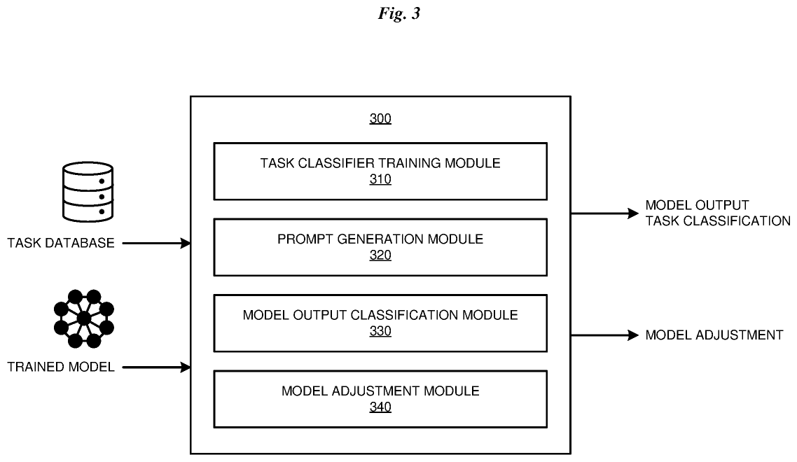

With reference to FIG. 3, this figure depicts a block diagram of an example configuration for model emergent capability analysis in accordance with an illustrative embodiment. Application 300 is the same as application 200 in FIG. 1.

In the illustrated embodiment, application 300 has access to a database, or dataset, of tasks. A task is a behavior, including one or a series of steps, performed by a model or a human, labelled with a category or description of the task. One presently available technique for assembling a database of tasks includes obtaining a sequence of observations of performance of one or more activities, clustering the observations to find commonly repeated sequences which could indicate repeating behaviors (i.e., tasks), and having human annotators distinguish between input sequences (which could be used as prompts) and subsequent outcomes, distinguish between successful and unsuccessful outcomes, and classify a sequence into one of a predefined set of task labels or task categories. Some example sources of observations of performance of one or more activities are data of sequences of websites visited and actions taken at one or more websites (e.g., while shopping online), data gathered via sensors (e.g., tracking object movement in a warehouse or along a supply chain), and transaction data (e.g., financial transaction data) among accounts or applications. Some examples of tasks involve product recommendations, warehouse resupply scheduling, and financial fraud detection. Task datasets are also available for purchase. Some presently available models (e.g., GPT-4) are also usable to generate new tasks (already-labelled, or for humans to label) and variations on existing tasks.

Task classifier training module 310 uses a presently available technique to train a classifier model to classify an input task into a task category in a plurality of predefined task categories. The technique uses a database of categorized tasks as training and testing data during model training. Some non-limiting examples of predefined task categories are source code generation, mathematical reasoning, product recommendations, warehouse resupply scheduling, financial fraud detection, and the like.

Prompt generation module 320 generates a plurality of prompts. A prompt is an input to a model, intended to invoke a particular model's capability.

In one prompt generation implementation, module 320 uses a presently available technique to train a reinforcement learning agent against one or more foundation models (of which at least one foundation model has a capability being prompted for) to generate prompts invoking a variety of tasks. In the reinforcement learning agent, creating prompts that generate model output that a trained task classifier correctly classifies as a novel task is rewarded. In one embodiment, the largest reward is given for new tasks, with a decreasing reward (according to a particular decay function) for tasks that the reinforcement learning agent has already triggered.

In another prompt generation implementation, module 320 uses a presently available genetic algorithm technique to alter one or more existing prompts in a prescribed manner, and rewarding prompts that generate model output that a trained task classifier correctly classifies as a novel task. In one implementation of module 320, the largest reward is given for new tasks, with a decreasing reward (according to a particular decay function) for tasks that the reinforcement learning agent has already triggered.

In another prompt generation implementation, module 320 uses a presently available model inversion technique to generate one or more prompts that best result in a desired model output. A model inversion technique starts with a desired model output (e.g., generating computer source code in the C language) and attempts to discover prompts that generate the desired result. One implementation of module 320 uses a presently available model inversion technique to prime the model, resulting in better prompts. For example, a model might be given several examples of a desired result and requested to provide a prompt that would produce a result resembling the examples. For example, a model might be prompted with several examples of C code and asked to provide a prompt that would produce a result resembling the given examples.

In another prompt generation implementation, module 320 uses a presently available adversarial example technique to generate prompts. An adversarial example technique starts with an initial prompt (e.g., from a task database) for which a model produces a result with a correctness below a correctness threshold, and adjusts the initial prompt in an attempt to cause the model to generate a result with a correctness closer to or above the correctness threshold. Module 320 adjusts the initial prompt by adding one or more characters to the initial prompt, removing one or more characters from the initial prompt, or replacing one or more characters in the initial prompt with different characters. Module 320 also uses a presently available natural language processing or natural language understanding technique to determine if an adjusted prompt retains a semantic meaning above a semantic meaning threshold (i.e., the adjusted prompt is not a meaningless string of letters and numbers) and to determine if an adjusted prompt is merely a request to echo the desired result.

To evaluate a trained model's capabilities, application 300 applies a prompt to the model, and the model responds to the prompt by producing a model output. The applied prompt is generated by module 320, or obtained from a task database or another source. Model output classification module 330 uses the trained classifier model to classify the model output into one of the classifier model's predefined task categories. Another implementation of module 330 uses the trained classifier model and the applied prompt to classify the model output into one of the classifier model's predefined task categories. For example, if the model responded to the prompt “what is x in x²+9=25” with “x=” followed by a number, module 330 might use the trained classifier model to classify the model output into the mathematical reasoning category. Note that the trained classifier model might classify the model output into the mathematical reasoning category even if the model's answer to the equation is not mathematically correct, as long as the answer has above a threshold amount of semantic similarity to a mathematically correct answer. As another example, if the model responded to the prompt “write C code to put a set of strings in alphabetical order” with some lines of C code, module 330 might use the trained classifier model to classify the model output into the source code generation category. Note that the trained classifier model might classify the model output into the code generation category even if the model's answer does not include the most efficient implementation of the requested code or includes a minor error, as long as the answer has above a threshold amount of semantic similarity to an answer deemed acceptable. The strictness of the trained classifier model's criteria for assigning a model output to a particular category is adjustable during model training. In one implementation of application 300, the strictness of the trained classifier model's criteria for assigning a model output to a particular category is a user-defined parameter. In addition, if a user specifies that model output can be assigned to a particular category (e.g., mathematical reasoning or source code generation) only if the result has above a threshold amount of correctness, one implementation of application 300 uses a presently available technique to evaluate the correctness of a result. For example, natural language understanding techniques are presently available to extract a mathematical expression from text output by an LLM and equation solving techniques are presently available to evaluate a correctness of the extracted mathematical expression. As another example, source code checking techniques are presently available to evaluate a correctness of generated source code.

Module 330 reports a model output's task categories, individually or aggregated, and automatically or upon request. For example, one implementation of module 330 might repeat a prompt generation and model output classification in response to generate prompts once per week, and report when a model generates above a threshold number of responses in a particular category (i.e., the model now appears to be able to perform a task in that category). As another example, module 330 might generate an aggregated report showing how many responses were in each category, or in a subset of the available categories (e.g., so far the model has produced five outputs in the code generation category and 2500 outputs in the mathematical reasoning category).

Module adjustment module 340 determines whether or not a model output is in an undesired task category. Some non-limiting examples of an undesired task category are the disclosure of private information (e.g., an employee's tax identification number or password), a type of model output that is inconsistent with a model's purpose (e.g., generating source code by a model intended to generate poetry or French text), and a type of output that might give rise to an unacceptable amount of legal or business risk (e.g., disclosure of an individual's legally protected information or a trade secret), and the like. If a model output is in an undesired task category, module 340 adjusts the model. The adjustment alters a capability of the trained model to perform a task in the first task category. To adjust a model, module 340 uses one or more presently available model alteration techniques to perform additional model training (optionally, with adjusted training data), adjust a limit on a model's output in response to a specific prompt or type of prompt, or a limit on a model's output to a specific user or category of user, or performs another model adjustment. For example, if a model output is classified in an (undesired) humor category, module 340 might retrain a model to adjust the type of humor being generated, instruct the model to explain that it is unable to generate a requested joke, instruct the model to explain that it is unable to generate a requested joke to a child user, and the like.

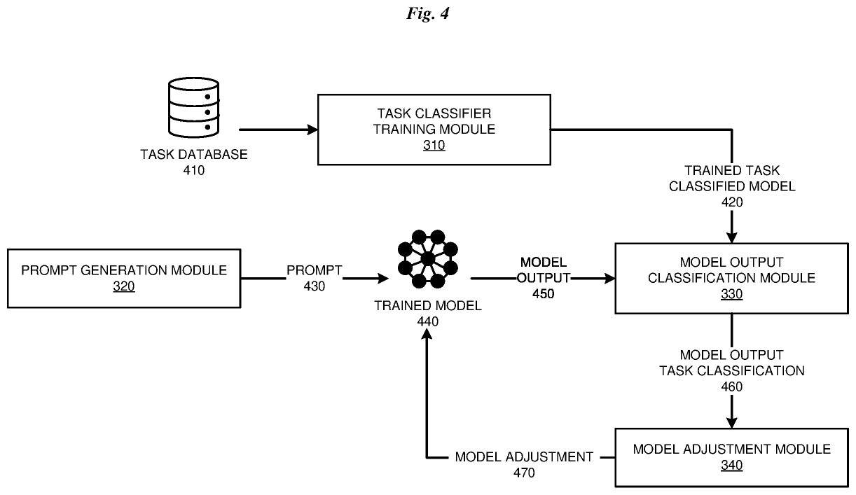

With reference to FIG. 4, this figure depicts a flow diagram of an example configuration for model emergent capability analysis in accordance with an illustrative embodiment. Steps in the flow diagram can be executing using application 300 in FIG. 3. Task classifier training module 310, prompt generation module 320, model output classification module 330, and module adjustment module 340 are the same as task classifier training module 310, prompt generation module 320, model output classification module 330, and module adjustment module 340 in FIG. 3.

As depicted, task classifier training module 310 uses a presently available technique to train a classifier model to classify an input task into a task category in a plurality of predefined task categories. The technique uses task database 410, a database of categorized tasks as training and testing data during model training, and generates trained task classifier model 420.

Prompt generation module 320 generates a plurality of prompts, including prompt 430. To evaluate trained model 440's capabilities, application 300 applies prompt 430 to trained model 440, and model responds to the prompt by producing model output 450. Model output classification module 330 uses the trained classifier model to classify the model output into one of the classifier model's predefined task categories, generating model output task classification 460. Module adjustment module 340 determines whether or not model output task classification 460 is in an undesired task category, and if so generates model adjustment 470 for trained model 440.

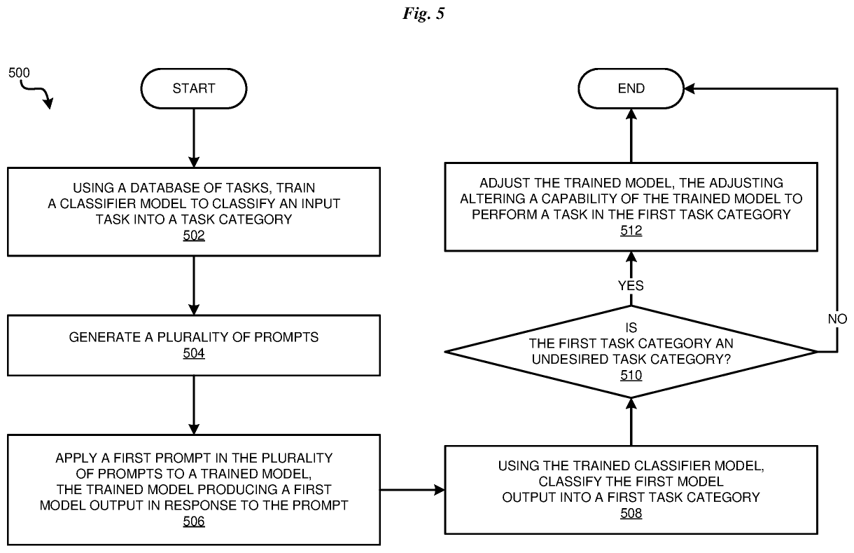

With reference to FIG. 5, this figure depicts a flowchart of an example process for model emergent capability analysis in accordance with an illustrative embodiment. Process 500 can be implemented in application 300 in FIG. 3.

In the illustrated embodiment, at block 502, the process, using a database of tasks, trains a classifier model to classify an input task into a task category. At block 504, the process generates a plurality of prompts. At block 506, the process applies a first prompt in the plurality of prompts to a trained model, the trained model producing a first model output in response to the prompt. At block 508, the process, using the trained classifier model, classifies the first model output into a first task category. At block 510, the process determines whether the first task category is an undesired task category. If yes (“YES” path of block 510), at block 512, the process adjusts the trained model, the adjusting altering a capability of the trained model to perform a task in the first task category. Then (also “NO” path of block 510) the process ends.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “illustrative” is used herein to mean “serving as an example, instance or illustration.” Any embodiment or design described herein as “illustrative” is not necessarily to be construed as preferred or advantageous over other embodiments or designs. The terms “at least one” and “one or more” are understood to include any integer number greater than or equal to one, i.e., one, two, three, four, etc. The terms “a plurality” are understood to include any integer number greater than or equal to two, i.e., two, three, four, five, etc. The term “connection” can include an indirect “connection” and a direct “connection.”

References in the specification to “one embodiment,” “an embodiment,” “an example embodiment,” etc., indicate that the embodiment described can include a particular feature, structure, or characteristic, but every embodiment may or may not include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

Thus, a computer implemented method, system or apparatus, and computer program product are provided in the illustrative embodiments for managing participation in online communities and other related features, functions, or operations. Where an embodiment or a portion thereof is described with respect to a type of device, the computer implemented method, system or apparatus, the computer program product, or a portion thereof, are adapted or configured for use with a suitable and comparable manifestation of that type of device.

Where an embodiment is described as implemented in an application, the delivery of the application in a Software as a Service (SaaS) model is contemplated within the scope of the illustrative embodiments. In a SaaS model, the capability of the application implementing an embodiment is provided to a user by executing the application in a cloud infrastructure. The user can access the application using a variety of client devices through a thin client interface such as a web browser (e.g., web-based e-mail), or other light-weight client-applications. The user does not manage or control the underlying cloud infrastructure including the network, servers, operating systems, or the storage of the cloud infrastructure. In some cases, the user may not even manage or control the capabilities of the SaaS application. In some other cases, the SaaS implementation of the application may permit a possible exception of limited user-specific application configuration settings.

Embodiments of the present invention may also be delivered as part of a service engagement with a client corporation, nonprofit organization, government entity, internal organizational structure, or the like. Aspects of these embodiments may include configuring a computer system to perform, and deploying software, hardware, and web services that implement, some or all of the methods described herein. Aspects of these embodiments may also include analyzing the client's operations, creating recommendations responsive to the analysis, building systems that implement portions of the recommendations, integrating the systems into existing processes and infrastructure, metering use of the systems, allocating expenses to users of the systems, and billing for use of the systems. Although the above embodiments of present invention each have been described by stating their individual advantages, respectively, present invention is not limited to a particular combination thereof. To the contrary, such embodiments may also be combined in any way and number according to the intended deployment of present invention without losing their beneficial effects.

What is claimed is:

1. A computer-implemented method comprising:
training, using a database of tasks, a classifier model to classify an input task into a task category, the training resulting in a trained classifier model;
generating a plurality of prompts;
applying a first prompt in the plurality of prompts to a trained model, the trained model producing a first model output in response to the first prompt;
classifying, using the trained classifier model, the first model output into a first task category;
determining that the first task category is an undesired task category; and
adjusting, responsive to determining the first task category is the undesired task category, the trained model, the adjusting altering a capability of the trained model to perform a task in the first task category.

2. The computer-implemented method of claim 1, wherein generating the plurality of prompts comprises training a reinforcement learning agent to reward a prompt invoking generation of a novel task higher than a prompt invoking generation of a non-novel task, the training resulting in a trained reinforcement learning agent.

3. The computer-implemented method of claim 2, wherein generating the plurality of prompts comprises using the trained reinforcement learning agent to reward a derived prompt, the derived prompt derived from an existing prompt.

4. The computer-implemented method of claim 1, wherein generating the plurality of prompts comprises prompting the trained model to generate a generated prompt, the generated prompt resulting in a desired output of the trained model.

5. The computer-implemented method of claim 1, wherein generating the plurality of prompts comprises adjusting an initial prompt producing an initial model output, the adjusting generated an adjusted prompt producing an adjusted model output, the initial model output having an initial correctness lower than a correctness threshold, the adjusted model output having an adjusted correctness higher than the initial correctness.

6. The computer-implemented method of claim 5, wherein the adjusted prompt has a semantic meaning above a semantic meaning threshold.

7. A computer program product comprising one or more computer readable storage media, and program instructions collectively stored on the one or more computer readable storage media, the program instructions executable by a processor to cause the processor to perform operations comprising:
training, using a database of tasks, a classifier model to classify an input task into a task category, the training resulting in a trained classifier model;
generating a plurality of prompts;
applying a first prompt in the plurality of prompts to a trained model, the trained model producing a first model output in response to the first prompt;
classifying, using the trained classifier model, the first model output into a first task category;
determining that the first task category is an undesired task category; and
adjusting, responsive to determining the first task category is the undesired task category, the trained model, the adjusting altering a capability of the trained model to perform a task in the first task category.

8. The computer program product of claim 7, wherein the stored program instructions are stored in a computer readable storage device in a data processing system, and wherein the stored program instructions are transferred over a network from a remote data processing system.

9. The computer program product of claim 7, wherein the stored program instructions are stored in a computer readable storage device in a server data processing system, and wherein the stored program instructions are downloaded in response to a request over a network to a remote data processing system for use in a computer readable storage device associated with the remote data processing system, further comprising:
program instructions to meter use of the program instructions associated with the request; and
program instructions to generate an invoice based on the metered use.

10. The computer program product of claim 7, wherein generating the plurality of prompts comprises training a reinforcement learning agent to reward a prompt invoking generation of a novel task higher than a prompt invoking generation of a non-novel task, the training resulting in a trained reinforcement learning agent.

11. The computer program product of claim 10, wherein generating the plurality of prompts comprises using the trained reinforcement learning agent to reward a derived prompt, the derived prompt derived from an existing prompt.

12. The computer program product of claim 7, wherein generating the plurality of prompts comprises prompting the trained model to generate a generated prompt, the generated prompt resulting in a desired output of the trained model.

13. The computer program product of claim 7, wherein generating the plurality of prompts comprises adjusting an initial prompt producing an initial model output, the adjusting generated an adjusted prompt producing an adjusted model output, the initial model output having an initial correctness lower than a correctness threshold, the adjusted model output having an adjusted correctness higher than the initial correctness.

14. The computer program product of claim 3, wherein the adjusted prompt has a semantic meaning above a semantic meaning threshold.

15. A computer system comprising a processor and one or more computer readable storage media, and program instructions collectively stored on the one or more computer readable storage media, the program instructions executable by the processor to cause the processor to perform operations comprising:
training, using a database of tasks, a classifier model to classify an input task into a task category, the training resulting in a trained classifier model;
generating a plurality of prompts;
applying a first prompt in the plurality of prompts to a trained model, the trained model producing a first model output in response to the first prompt;
classifying, using the trained classifier model, the first model output into a first task category;
determining that the first task category is an undesired task category; and
adjusting, responsive to determining the first task category is the undesired task category, the trained model, the adjusting altering a capability of the trained model to perform a task in the first task category.

16. The computer system of claim 15, wherein generating the plurality of prompts comprises training a reinforcement learning agent to reward a prompt invoking generation of a novel task higher than a prompt invoking generation of a non-novel task, the training resulting in a trained reinforcement learning agent.

17. The computer system of claim 16, wherein generating the plurality of prompts comprises using the trained reinforcement learning agent to reward a derived prompt, the derived prompt derived from an existing prompt.

18. The computer system of claim 15, wherein generating the plurality of prompts comprises prompting the trained model to generate a generated prompt, the generated prompt resulting in a desired output of the trained model.

19. The computer system of claim 15, wherein generating the plurality of prompts comprises adjusting an initial prompt producing an initial model output, the adjusting generated an adjusted prompt producing an adjusted model output, the initial model output having an initial correctness lower than a correctness threshold, the adjusted model output having an adjusted correctness higher than the initial correctness.

20. The computer system of claim 19, wherein the adjusted prompt has a semantic meaning above a semantic meaning threshold.
